(19) United States
(12) Patent Application Publication
(10) Pub. No.: US 2005/0021492 A1
(43) Pub. Date: Jan. 27, 2005

(54) On-line sales analysis system and method

(76) Inventors: Aman Safaei, Pleasantville, NY (US); Wen Rong Wu, Bayside, NY (US)

Correspondence Address: DUANE MORRIS, LLP;IP DEPARTMENT, ONE LIBERTY PLACE, PHILADELPHIA, PA, 19103-7396, US

(21) Appl. No.: 10/660,409

(22) Filed: Sep. 10, 2003

Related U.S. Application Data
(60) Provisional application No. 60/410,659, filed on Sep. 13, 2002.
(60) Provisional application No. 60/410,658, filed on Sep. 13, 2002.

(51) Int. Cl. G06F 7/00

(52) U.S. Cl. 707/1

(57) ABSTRACT

A computer implemented method for processing lottery sales data comprises the steps of: enabling a user of a computer to query data representing lottery ticket sales for a plurality of lottery retailers based on at least one criterion from a predetermined list of criteria; and causing display of a table on a computer, the table containing a listing of a subset of lottery retailers from the plurality of lottery retailers that meet the at least one criterion, the table further containing data representing lottery ticket sales associated with the subset of retailers.

This application claims the benefit of U.S. Provisional Application No. 60/410,659, filed Sep. 13, 2002 and U.S. Provisional Application No. 60/410,658, filed Sep. 13, 2002.

### FIELD OF THE INVENTION

The present invention relates generally to computer networks and the like, and more particularly to systems and methods for enabling lottery administrators to analyze lottery sales data, particularly sales data for on-line and instant lottery tickets.

### BACKGROUND OF THE INVENTION

Lottery sales are an important source of revenue for many states. However, the teachings of the prior art do not provide tools that lottery administrators can use to easily evaluate sales data relevant to instant and on-line lottery ticket sales by lottery agents or retailers.

### SUMMARY OF THE INVENTION

In some embodiments, a computer implemented method for processing lottery sales data comprises the steps of: enabling a user of a computer to query data representing lottery ticket sales for a plurality of lottery retailers based on at least one criterion from a predetermined list of criteria; and causing display of a table on a computer, the table containing a listing of a subset of lottery retailers from the plurality of lottery retailers that meet the at least one criterion, the table further containing data representing lottery ticket sales associated with the subset of retailers.

In some embodiments, a computer implemented method of processing lottery sales data comprises the steps of: causing display of a table on a computer, the table containing data representing lottery ticket sales for a plurality of lottery retailers, wherein the table contains values of an index that compares sales performance of each of the lottery retailers listed in the table; enabling a user of the computer to query the data in the table based on at least one criterion from a predetermined list of criteria; and modifying the table to contain a listing of a subset of lottery retailers from the plurality of lottery retailers that meet said at least one criterion, said table further containing data representing lottery ticket sales associated with said subset of retailers, wherein modified values are displayed comparing sales performance of the subset of retailers.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is a stylized overview of a system of interconnected computer networks;

FIG. 2 shows a Sales Analysis page displayed by the system of FIG. 1;

FIG. 3 shows a map indicating a retailer location displayed by the system of FIG. 1;

FIG. 4 shows a sales summary for an individual retailer displayed by the system of FIG. 1;

FIG. 5 shows a Sales Analysis page displayed by the system of FIG. 1 for a subset of retailers;

FIG. 6 shows a Report Page displayed by the system of FIG. 1;

FIG. 7 shows a summary report displayed by the system of FIG. 1; and

FIG. 8 shows a sales summary displayed by the system of FIG. 1.

### DETAILED DESCRIPTION

U.S. Provisional Application Nos. 60/410,659 and 60/410,658, both filed Sep. 13, 2003, are incorporated by reference herein in their entirety.

The Internet is a worldwide system of computer networks—a network of networks in which a user at one computer can obtain information from any other computer and communicate with users of other computers. The most widely used part of the Internet is the World Wide Web (often-abbreviated “WWW” or called “the Web”). One of the most outstanding features of the Web is its use of hypertext, which is a method of cross-referencing. In most Web sites, certain words or phrases appear in text of a different color than the surrounding text. This text is often also underlined. Sometimes, there are hot spots, such as buttons, images or portions of images that are “clickable.” Clicking on hypertext or a hot spot causes the downloading of another web page via a protocol such as hypertext transport protocol (HTTP). Using the Web provides access to millions of pages of information. Web “surfing” is done with a Web browser, the most popular of which presently are Netscape Navigator and Microsoft Internet Explorer. The appearance of a particular website may vary slightly depending on the particular browser used. Recent versions of browsers have “plug-ins,” which provide animation, virtual reality, sound and music and interpreted programs (e.g., applets) may be run within the browser.

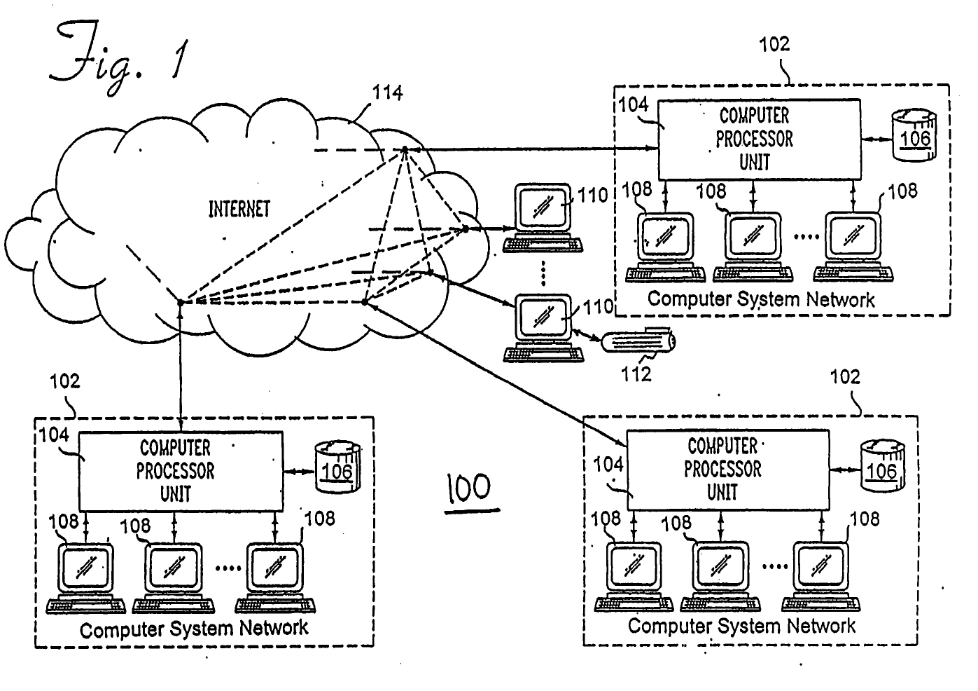

FIG. 1 shows a system 100 of interconnected computer system networks 102. Each computer system network 102 contains a corresponding local computer processor unit 104, which is coupled to a corresponding local data storage unit 106, and local network user terminals 108. A computer system network 102 may be a local area network (LAN) or part of a wide area network (WAN), for example. The local computer processor units 104 are selectively coupled to a plurality of user devices 110 through Internet 114 described above. Each of the plurality of user devices 110 and local user terminals 108 (collectively, user terminals) may have various devices connected to their local computer systems, such as scanners, barcode readers, printers, finger print scanners, mouse devices, and other interface devices 112.

A user device 110, programmed with a Web browser or other software, locates and selects (such as by clicking with a mouse) a particular Web page, the content of which is located on the local data storage unit 106 of a computer system network 102, in order to access the content of the Web page. The Web page may contain links to other computer systems and other Web pages.

The user device 110 may be a microprocessor-based computer terminal, a pager that can communicate through the Internet using the Internet Protocol (IP), a Kiosk with Internet access, a connected personal digital assistant or PDA (e.g., a PALM device manufactured by Palm, Inc. or IPAQ device available from Compaq) or other device capable of interactive network communications, such as an electronic personal planner. User device 110 may also be a wireless device, such as a hand-held unit (e.g., cellular telephone) that connects to and communicates through the Internet using the wireless access protocol (WAP).

The system and method of the present invention may be implemented by utilizing at least a part of the system 100 described above in connection with FIG. 1. It should be apparent to one of ordinary skill that the system may be incorporated in a LAN, in a WAN, or through an Internet 114 based approach, such as through a hosted or non-hosted application service, or through a combination thereof. The functionality of the method may be programmed and executed by at least one computer processor unit 104, with necessary data and graphical interface pages as described below stored in and retrieved from a data storage unit 106. A user can access this functionality using a user device 110 or computer terminal 108.

Described below are a sales analysis and reporting system and method preferably embodied utilizing the network structure described above, i.e., as an application service provided through the Internet in some embodiments. The system and method allow state lottery administrators, particularly their sales representatives and marketing agents, to easily evaluate sales data relevant to instant and on-line lottery ticket sales by lottery agents or retailers (hereinafter, “retailers”). The term “on-line” lottery ticket means a ticket usable in lottery games sold most prominently at convenience stores, for example, where a lottery retailer uses a lottery terminal connected to a backend lottery processor via a communications network to issue lottery tickets to customers. Such games are distinguishable from so called “instant” or “scratch-off” lottery tickets. Examples of on-line games include the ubiquitous “pick 3,” “pick 4” and “pick 6” games. The system described below provides a powerful tool for lottery administrators to examine and evaluate sales data for all or some of the retailers, generate reports and utilize the data in various decision making processes, such as franchise location and allocation.

Embodiments of a system and method are described below using various Graphical User Interfaces (GUIs) including Web pages caused to be displayed to a user on a computer. It should be understood that various selectable options presented by the Web pages correspond to functionality provided by a computer processor unit 104 that may be programmed in any number of ways and that this disclosure should not be limited to any particular programming language or methodology. In some embodiments, the system is implemented to include a commercially available off-the-shelf database management system (DBMS) to manage the data, such as, for example, SQL Server by Microsoft Corporation of Redmond, Wash., or Oracle9i from Oracle Corporation of Redwood Shores, Calif. or DB2 from IBM Corporation of Armonk, N.Y.

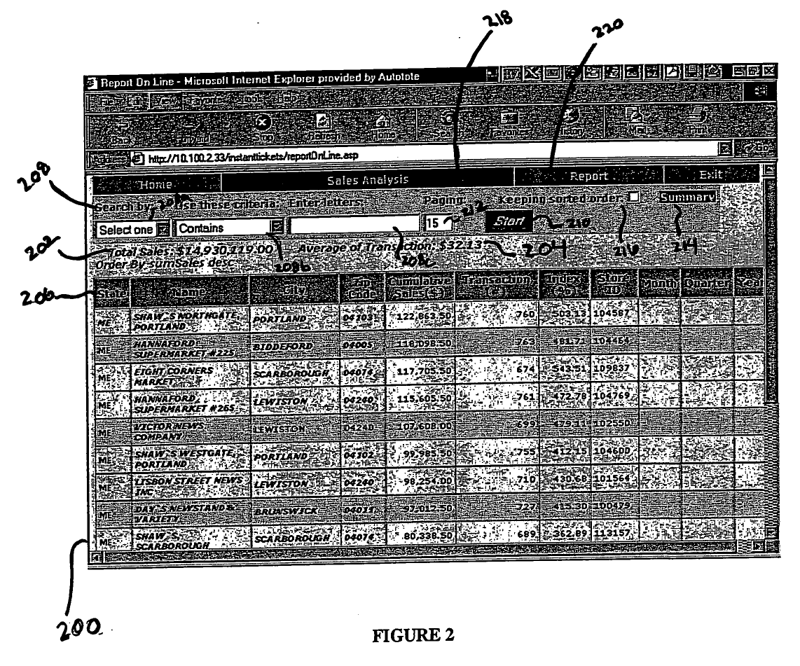

FIG. 2 is a display of a graphical user interface (GUI) page 200 that enables a lottery administrator user to access the functionality of the system and methods described herein. In one embodiment, the user can access the Web page 200 of FIG. 2 through Internet 114 and preferably using a user name and password associated with data available to the user. Lottery sales data relevant to individual instant and on-line lottery games, such as “pick 3,” “pick 4,” and “pick 6” games, for various states are entered and stored in a data storage unit 106 for retrieval and use. The lottery sales data are periodically collected in a database in data storage unit 106, preferably on a daily basis. This data may be exported from a central lottery processor that logs lottery ticket sales made by the various lottery terminals at retailers distributed through, for example, a state. Sales data may include the type of ticket(s) sold (e.g., “pick 3” or “pick 4” or instant), the sales amount in dollars, the date of sales, the number of tickets sold, and the lottery retailer that sold the ticket(s). This information can then be accessed, parsed, organized and reviewed by a lottery administrator as described below.

Referring again to selectable “Sales Analysis” option 218, a “Sales Analysis” GUI 200 (displayed by selecting “Sales Analysis” button 218) is shown displayed in a browser window. In this example, the lottery administrator user has access to lottery sales data for Maine (ME). The option allows the administrator to review, parse and organize the lottery data pertinent to that state's (and/or other states') games. The display preferably defaults to listing sales data for each lottery retailer in the state. The list of retailers is searchable and reorganizeable in much the same way as the graphical user interface described in U.S. Published patent application 2002/0077712 to Safaei et al., entitled “System and Method for Providing Return on Investment Data for Wagers,” published Jun. 20, 2002, the entirety of which is hereby incorporated by reference herein.

The display 200 shows the cumulative “Total Sales” 202 for all lottery games for the state (or group of states depending on the user' access rights) over a predefined time period, such as from January 1 of the current year to the current date. The “Total Sales” value can be calculated from the sales data described above that is periodically accumulated in data storage unit 106. The “Average of Transaction” value 204 for the retailers for that period of time is also indicated. This value can be calculated from the aforementioned sales data by dividing the “Total Sales” number by the total number of transactions for the defined period. In some embodiments, the sales of a lottery game in a day is considered a “transaction.” By way of example, if a retailer sells one “Pick 3” ticket for $1 and one “Pick 4” ticket for $1 on a given day, that constitutes two transactions for a total of $2. The average transaction value for this retailer is $1, i.e., $2 in total sales divided by two transactions. If another retailer on a given day sells one hundred “Pick 3” tickets for $100, one hundred “Pick 4” tickets for $100 and one hundred “Pick 6” tickets for $100, that constitutes three total transactions for the day for a total of $300. The second retailer, therefore, has an average transaction value of $100, i.e., $300 in total sales divided by three transactions.

Also shown in the display 200 of FIG. 2 is a table with column headings 206 including “State,” “Name,” “City,” “Zip Code,” “Cumulative Sales ($),” “Transaction (#),” “Index (%)” and “Store ID.” “State” indicates the state of a lottery retailer, for example Maine (ME). “Name” identifies the name of a lottery retailer, and “City” and “Zip Code” identify the city name and zip code of the named lottery retailer, respectively. “Cumulative Sales” identifies the total cash value of sales for the lottery retailer over the defined period of time (here the default period of time), and “Transaction Number” indicates the total number of lottery transactions that produced the indicated sales. The retailers average transaction could be calculated by dividing the Cumulative Sales by the Transaction Number. For example, Shaw's Northgate Portland would have an average transaction value of approximately $160; that is an average of $160 per day per transaction.

The “Index (%)” identifies a normalized percentage comparing the individual lottery retailer's sales relative to the average retailer in the displayed group. For example, the value “503.13” in the first row represents that the “Shaw's Northgate, Portland” retailer performed 503.13% better (or approximately 5 times better) than the average lottery agent represented in the chart (in this case, the average lottery agent in the state of Maine). In one embodiment, the comparison is based on the average transaction value for the given time period, i.e., the sales for the time period divided by the number of transactions.

Although “Shaw's Northgate, Portland” did more gross sales than “Eight Corner's Market,” the display indicates that Eight Corners Market has a higher index percentage. Eight Corners Market did almost the same amount of gross sales as Shaw's, but on significantly fewer transactions (674 vs. 760 transactions). As mentioned, a transaction is based on the sale of a game on a given day (i.e., the sale of each ticket is not an individual transaction, rather the occurrence of the sale of a ticket for a game on a given day, regardless of the number of tickets sold, is a transaction). One possible reason for Eight Corners having significantly fewer transaction for the period than Shaw's could be that it is open fewer days per week.

Finally, “Store ID” is a unique identifier for the lottery agent in the lottery system.

As mentioned above, the table of the GUI 200 of FIG. 2 preferably defaults to order the lottery retailers by cumulative sales (or other criterion) for the default time period, as shown in FIG. 2. The lottery data are preferably listed in columns that are reorganizeable. By selecting (e.g., “clicking”) on a column heading 206, the table is reorganized, e.g., reordered, and displayed based upon that heading criterion. For example, if “Transaction (#)” is selected, the retailers are reordered in descending order by number of transactions for the retailers. “Clicking” the heading again reverses the order, i.e., the lottery retailers are ordered in ascending order from the retailer with the lowest number of transactions to the retailer with the highest number of transactions. Similarly, the chart can be reorganized by city name (e.g., by alphabetical order), by lottery retailer name (e.g., by alphabetical order), by zip code (e.g., numerical order), Index percentage (e.g., numerical order) and store ID (e.g., numerical order) or any other criterion that is provided in the table.

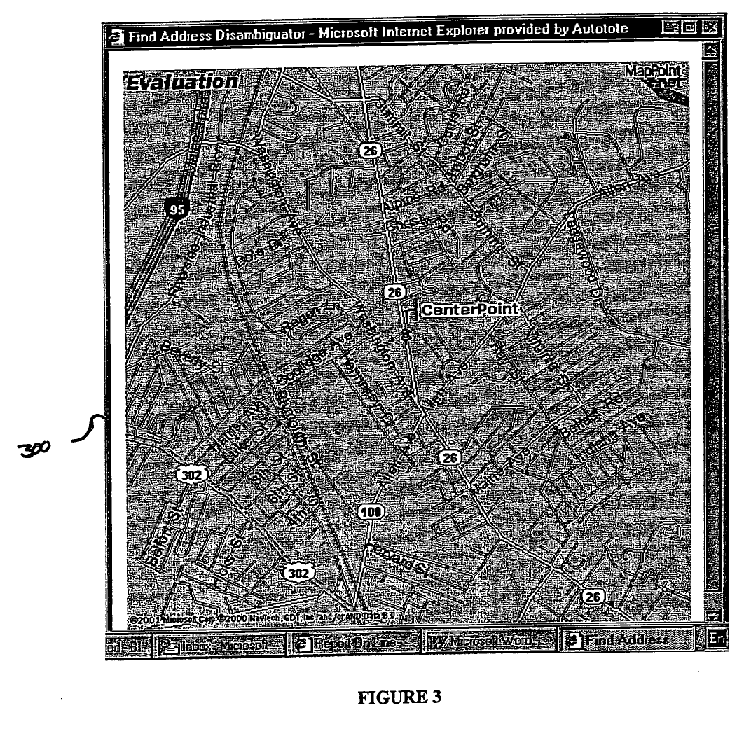

In one embodiment, selecting a particular retailer name from the “Name” column by “clicking” on the name with a mouse or other interface device opens a map display popup screen 300 as shown in, for example, FIG. 3. The tack icon below the “Center Point” label identifies to the user the location of the retailer on the displayed map. This feature allows a lottery administrator user that must visit a retailer to quickly and easily find directions to the retailer. The map display may be retrieved from map data in data storage unit 106 and be generated originally using the retailer's address and mapping software, such MICROSOFT® MAPPOINT® Web Service from Microsoft Corporation of Redmond, Wash.

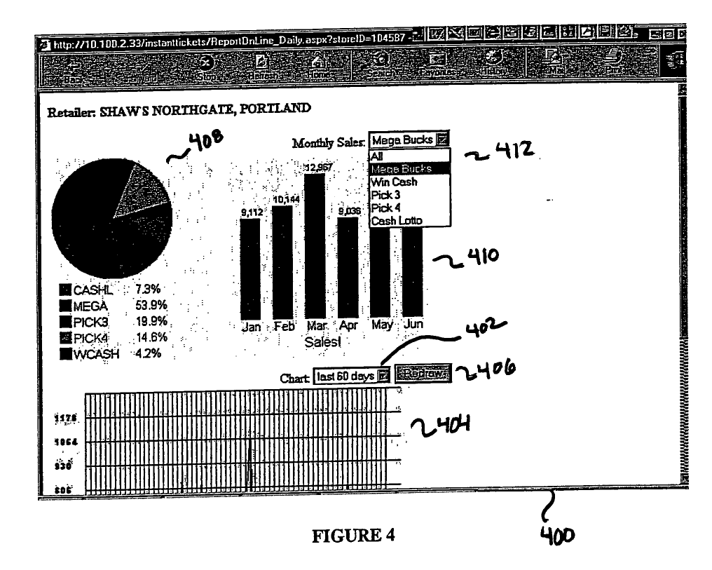

In one embodiment, selecting (e.g., “clicking”) an Index percentage value from the “Index (%)” column for a particular retailer opens a popup window display 400 that graphically depicts sales information for that specific retailer as shown in, for example, FIG. 4. FIG. 4 shows a display 400 including exemplary graphical depictions of sales for a defined period of time for the retailer Shaw's Northgate, Portland. Exemplary graphs include a pie chart 408 showing the breakdown of sales at that retailer for a selected time period (e.g., January through the current month) and by game, i.e., for the CASHL, MEGA, PICK3, PICK 4, and WCASH games. Monthly sales volume can also be shown as a bar graph for a selected game or games (e.g., “All” games, “Mega Bucks,” “Win Cash,” “Pick 3,” “Pick 4” and “Cash Lotto”) as selected using pull down window 412. The line graph 404 (shown in partial) shows the daily sales for the period designated in window 402 and for the game(s) selected using window 412. Different time periods, limited only by the available sales data, may be selected using the pull down window 402. Entering a new time frame in window 402 (such as “last 60 days”), followed by the selection of the “Redraw” button 406 causes the regeneration and redisplay of the line graph 404 of FIG. 4 for the selected time period.

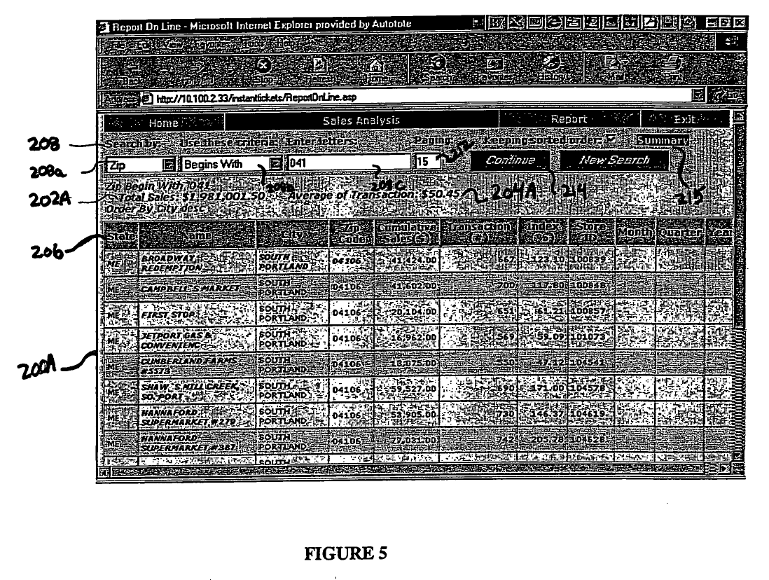

Referring again to FIG. 2, in one embodiment the display 200 enables the user to enter queries for searching the sales data in the displayed table in order to identify a subset of the retailers that satisfy the at least one criterion selected by the user. Search prompts shown at 208 allow the user to search the sales data for specific information. A sales table is shown in the display 200A of FIG. 5 that has been displayed according to the selected criteria from a user's query. As shown in FIG. 5, the redisplayed table lists retailers having zip codes that “Begin With” the number “041.” In order to generate such a chart and referring to the search criteria windows 208 shown above the table, the user selects “zip” from the first pull down window 208a, selects the command “Begins With” from the second pull down window 208b and enters the limitation “041” in the third window 208c. The user then selects the “Start” button 210 to perform the search. The “Paging” window 212 determines how many search results (i.e., retailers) should be listed on any one Web page display. The “Total Sales” 202A and “Average of Transaction” 204A values are also recalculated and displayed in connection with the table based upon the sales data for the subset of retailers that satisfy the search criteria selected by the user. In the example of FIG. 5, the total sales for all retailers located within a zip code that begins with 041 for the defined period of time is “$1,981,001.50” and the average transaction value is “$50.45.” Similarly, the Index % values for each retailer within the subset—the retailers that satisfy the search criteria—are recalculated relative to the average retailer of the group. Incorporation of a DBMS in the system platform facilitates this expanded search capability.

The GUI preferably provides the user the ability to search via search prompts 208 by the following exemplary criteria: retailer name, city, zip code, store ID, state (if data for retailers in more than one state is available to the user), game type or any other available sales data. Combinations of search criteria are also preferably available, such that the user is enabled to search, for example, for all retailers located in a combination of zip codes or states in order to define a specific sales territory or region or for all retailers in a specific city or cities by a certain name (e.g., “7-Eleven”). In one embodiment, this multi-tiered searching may be accomplished by selecting the “Continue” button 214 and adding an additional query using the search prompts 208. The results of the new search, along with recalculated “Total Sales” and “Average of Transaction” values for the new subset of retailers and respective index percentages, are then displayed in a redisplayed table (not shown).

As described above, the table of FIG. 2 may be reorganized by a selected criterion by selecting column headings 206 in order to display a table having reordered retailers. This feature may also be used in the search results display of FIG. 5 in order to reorganize the display of the subset of retailers to facilitate customized review of the sales data. The map and sales summary graph features as described above are also available in the display of FIG. 5 by “clicking” or otherwise selecting on the name and Index % value of a retailer, respectively, in FIG. 5.

In this manner, the system provides the user with a tool that allows the user to define a search of the available sales data to identify sales data particularly relevant to the user's specific purpose such as analyzing sales data for specific time periods, geographic areas, retailers or combinations thereof. This ability allows the user to then make informed assessments on such decisions as sales trends, retailer locations, game comparison and retailer comparisons.

The GUI display 200 of FIG. 2 also includes “Month”, “Quarter” and “Year” elements included in column headings 206. By selecting the “Month” heading, for example, the monthly sales for the retailers are calculated and the retailers are reordered according to the sales for the current month. By selecting the “Quarter” heading, the retailers are reordered according to the sales for the current quarter, and likewise for the “Year” heading.

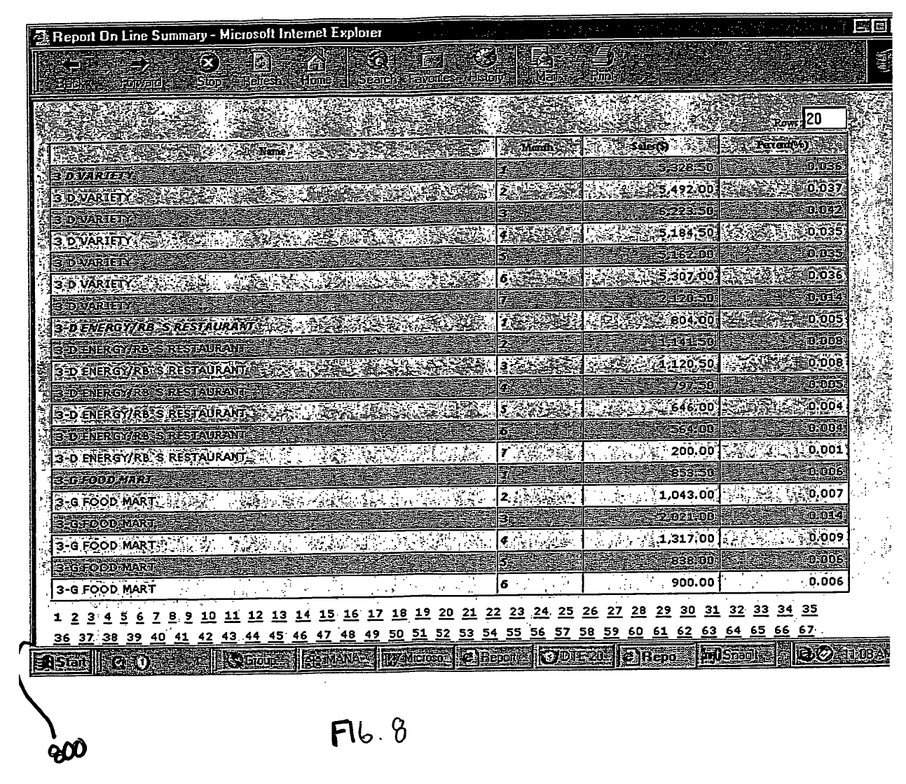

Assuming more detailed information is desired, summaries of the sales data indicated in each column can be obtained by selecting the “Summary” button 215 on the GUI of FIG. 2. For example, selecting the column heading “Month” followed by selecting “Summary” button 215 provides the user with a month-by-month summary of the sales volume for each month for the group of retailers shown in the table of FIG. 2 (or for the subset of retailers shown in the table of FIG. 5 as the case may be). FIG. 8 shows a display 800 of a chart indicating month-by-month sales data for each retailer from a group of retailers. Rather than merely showing the cumulative sales of the group per month, an alphabetic list of retailers is provided showing the monthly sales for each retailer. The percentage of the totals sales of the group for the year that are attributed to each retailer's monthly sales may also be shown.

As shown in FIG. 8, the retailers from the retailer group are listed in alphabetic order. Assuming the user had already defined an order, such as by selecting a column heading 206 in the display of either FIG. 2 or FIG. 5, selecting the column heading, followed by the “Keeping sorted order” button 216 followed by “Month” (or “Quarter” or “Year”) and then “Summary” provides a summary table of sales data per month per the selected “kept” order (e.g., “retailer name”). In a similar fashion, summaries may be obtained by city or zip code on a total, monthly, quarterly, or yearly basis. In relational database terms, the “Summary” function is a “drill-up” data retrieval function. Typically, relational databases only allow for the retrieval to go up one level of data. By combining providing the “Summary” function and “keep sorted order functions,” however, a multi-level drill-up retrieval function is provided. This provides a powerful tool for analyzing the sales data, observing trends, and comparing time periods and regions, particularly in combination with the search functions described above that allow the user to narrow or limit the displayed retailer list according to selected sales data or other information, such as zip code, city or retailer name.

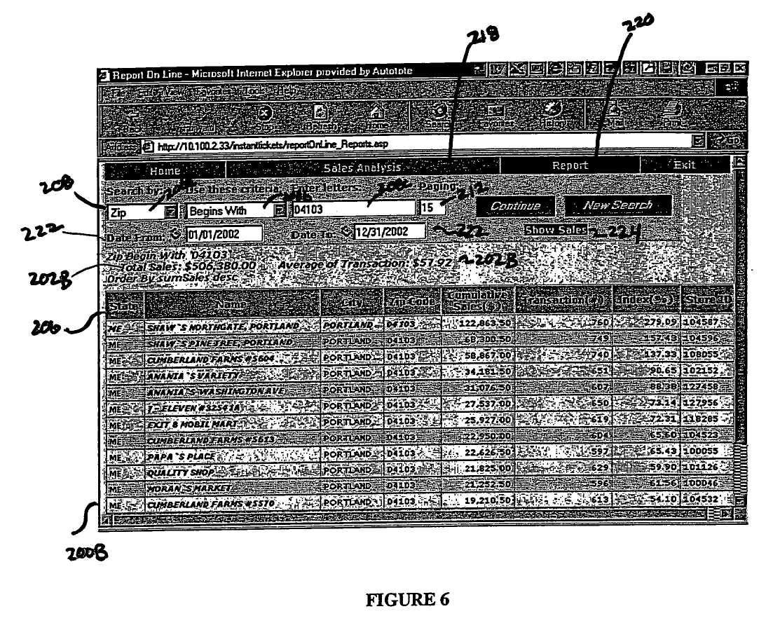

The “Report” feature of the system is now described. This functionality may be accessed by selecting the “Report” button 220 in FIG. 2, causing the display of the Reporting display 200B of FIG. 6. Once “Report” is selected, a Report GUI 200B showing a comprehensive table like FIG. 2 (i.e., all retailers are listed in an order defined by a default piece of sales data, such cumulative sales) is displayed to the user, only with modified query options as shown in FIG. 6. Like FIG. 2, the retailer list of FIG. 6 may be reorganized by the user by selecting a column heading 206 and may be searched by any combination of available sales data using query windows 208. For example, the table of FIG. 6 shows the subset of retailers having zip codes beginning with “04103.” Like the Sales Analysis GUI 200 of FIG. 2, the user may also “click” on an individual retailer's name in the table of FIG. 6 to obtain a map showing the retailer's location (as shown in FIG. 3 for example). Further, by clicking on an Index percentage value associated with a specific retailer, graphical sales information is displayed to the user (as shown in FIG. 4 for example).

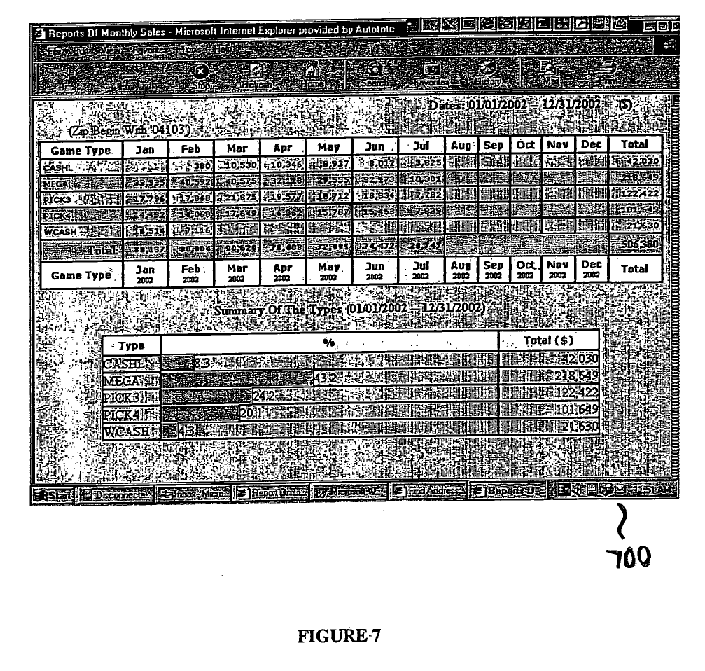

By selecting the “Show Sales” button 224, a summary of sales (i.e., a sales report”) for the subset of retailers that satisfied the search request and for a time period specified by the user in the date range windows 222 (i.e., Jan. 1, 2002-Dec. 31, 2002) is displayed to the user. An exemplary report 700 is shown in FIG. 7. The report shows detailed sales data for the subset of retailers that satisfied the search criteria. In one embodiment, cumulative sales for the group of retailers are shown for each game for each month during the selected time period. The respective percentage of the total sales attributed to each game may also be displayed.

As mentioned above, the user preferably can access the aforementioned sales data and functionality via a variety of user devices, such as a computer programmed with a web browser and a PDA or other mobile device. For mobile devices, functionality may be scaled back if bandwidth considerations are a factor. The system should still provide the above-described Sales Analysis and Reporting features. For the Sales Analysis feature, the mobile system preferably enables the user to locate a retailer store by zip code or city, view the location of the retailer store on a map and view the corresponding pie graph, bar graph and/or line graph for a parsed list of retailers (i.e., the subset of retailers provided as the result of a user query) according to the user's search criteria. For the Report feature, the mobile system preferably at least provides the user the ability to retrieve and view sales information by game type and city or zip code and view a report thereof as described above.

In one exemplary embodiment, the system also includes a voice recognition server that utilizes natural language voice recognition technology. Voice recognition servers are available from such companies as VoiceGenie Technologies Inc. of Toronto, Ontario, Canada, IBM Corporation of Armonk, N.Y. and Nuance Communications of Menlo Park, Calif. When a sales person visits a retailer, the sales person may place a call into the voice server, which has access to the sales data in data storage unit 106. The sales person can specify the retailer, and the voice server then recognizes the retailer and retrieves sales data for the retailer from the data storage unit 106. The sales data can then be read to the sales person using a text to speech translation, or the sales data may be directed to the mobile user terminal of the sales person for review. Similar functionality can be achieved using voice responsive systems, also known as Interactive Voice Response (IVR) systems.

The system and method described herein allow lottery administrators to easily navigate a large amount of sales data and evaluate relevant sales data respective to various lottery ticket sales by lottery retailers, particularly with respect to on-line lottery ticket sales and instant tickets. In so doing, the lottery administrators can evaluate games relative to each other, evaluate retailer performance, and territorial performance. Implementing the system and method via a mobile platform enables lottery administrators to obtain up-to-date and valuable information when in the field (i.e., when visiting retailers), as well as map information to help the administrator locate the retailer.

The present invention can be embodied in the form of methods and apparatus for practicing those methods. The present invention can also be embodied in the form of program code embodied in tangible media, such as floppy diskettes, CD-ROMs, DVD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention

1. A computer-implemented method for processing lottery sales data, comprising the steps of:
(a) enabling a user of a computer to query data representing lottery ticket sales for a plurality of lottery retailers based on at least one criterion from a predetermined list of criteria; and
(b) causing display of a table on a computer, said table containing a listing of a subset of lottery retailers from said plurality of lottery retailers that meet said at least one criterion, said table further containing data representing lottery ticket sales associated with said subset of retailers.

2. The method of claim 1, wherein said enabling step (a) includes the steps of:
causing display of a table on said computer, said table containing a listing of the plurality of lottery retailers and data representing lottery ticket sales associated with said plurality of lottery retailers; and
causing display of query prompts along with said table for selecting said at least one criterion for said query.

3. The method of claim 1, wherein said query includes multiple conditions.

4. The method of claim 1, wherein said table contains values of an index that compares sales performance of each of the lottery retailers listed in said table.

5. The method of claim 1, wherein only data corresponding to the subset of the lottery retailers that satisfy the query are included in the displayed table.

6. The method of claim 1, wherein said data representing lottery ticket sales associated with said subset of retailers represent total sales of said subset, average transaction value of said subset or both.

7. The method of claim 6, wherein said sales data representing total sales represent total sales by time period, by lottery game or by combination thereof, said method further comprising the step of causing said sales data representing said total sales to be displayed to said user on said computer in a chart or graph.

8. The method of claim 1, further comprising the step of automatically generating and displaying a summary report of said data representing lottery ticket sales associated with said subset of retailers.

9. The method of claim 1, further comprising:
receiving a modification to the query input by the user; and
dynamically redisplaying said table in accordance with said modification.

10. The method of claim 1, wherein the data are stored in a second computer, and the first computer used by the user is connected to the second computer by way of the Internet.

11. The method of claim 1, further comprising the step of:
causing to be displayed on said computer a map indicating a location of a retailer selected by said user from said subset of retailers.

12. The method of claim 1, further comprising the step of:
causing to be displayed on said computer a graphical presentation of sales data specific to a retailer selected by said user from said subset of retailers.

13. The method of claim 12, further comprising the steps of:
enabling a user of said computer to select at least one criterion from a predetermined set of criteria for displaying said graphical presentation; and
modifying and causing to be displayed said graphical presentation according to said at least one criterion selected by said user.

14. The method of claim 12, wherein said at least one criterion for displaying said graphical presentation includes game type or time period or both.

15. A computer readable medium encoded with computer program code, wherein when the computer program code is executed by a processor, the processor performs a computer implemented method for processing lottery sales data, comprising the steps of:
(a) enabling a user of a computer to query data representing lottery ticket sales for a plurality of lottery retailers based on at least one criterion from a predetermined list of criteria; and
(b) causing display of a table on a computer, said table containing a listing of a subset of lottery retailers from said plurality of lottery retailers that meet said at least one criterion, said table further containing data representing lottery ticket sales associated with said subset of retailers.

16. A computer implemented system for processing lottery sales data, comprising:
(a) means for enabling a user of a computer to query data representing lottery ticket sales for a plurality of lottery retailers based on at least one criterion from a predetermined list of criteria; and
(b) means for causing display of a table on a computer, said table containing a listing of a subset of lottery retailers from said plurality of lottery retailers that meet said at least one criterion, said table further containing data representing lottery ticket sales associated with said subset of retailers.

17. The system of claim 16, further comprising:
means for causing display of a table on said computer, said table containing a listing of the plurality of lottery retailers and data representing lottery ticket sales associated with said plurality of lottery retailers; and
means for causing display of query prompts along with said table for selecting said at least one criterion for said query.

18. The system of claim 16, wherein said query includes multiple conditions.

19. The system of claim 16, wherein said table contains values of an index that compares sales performance of each of the lottery retailers listed in said table.

20. The system of claim 16, wherein only data corresponding to the subset of the lottery retailers that satisfy the query are included in the displayed table.

21. The system of claim 16, wherein said data representing lottery ticket sales associated with said subset of retailers represent total sales of said subset, average transaction value of said subset or both.

22. The system of claim 21, wherein said sales data representing total sales represent total sales by time period, by lottery game or by combination thereof, said system further comprising means for causing said sales data representing said total sales to be displayed to said user on said computer in a chart or graph.

23. The system of claim 16, further comprising means for automatically generating and displaying a summary report of said data representing lottery ticket sales associated with said subset of retailers.

24. The system of claim 16, further comprising:
means for receiving a modification to the query input by the user; and
means for dynamically redisplaying said table in accordance with said modification.

25. The system of claim 16, wherein the data are stored in a second computer, and the first computer used by the user is connected to the second computer by way of the Internet.

26. The system of claim 16, further comprising means for causing to be displayed on said computer a map indicating a location of a retailer selected by said user from said subset of retailers.

27. The system of claim 16, further comprising the step of:
means for causing to be displayed on said computer a graphical presentation of sales data specific to a retailer selected by said user from said subset of retailers.

28. The system of claim 27, further comprising the steps of:
means for enabling a user of said computer to select at least one criterion from a predetermined set of criteria for displaying said graphical presentation; and
means for modifying and causing to be displayed said graphical presentation according to said at least one criterion selected by said user.

29. The system of claim 28, wherein said at least one criterion for displaying said graphical presentation includes game type or time period or both.

30. A computer implemented method of processing lottery sales data, comprising the steps of:
(a) causing display of a table on a computer, the table containing data representing lottery ticket sales for a plurality of lottery retailers, wherein said table contains values of an index that compares sales performance of each of the lottery retailers listed in said table;
(b) enabling a user of the computer to query the data in the table based on at least one criterion from a predetermined list of criteria; and
(c) modifying the table to contain a listing of a subset of lottery retailers from said plurality of lottery retailers that meet said at least one criterion, said table further containing data representing lottery ticket sales associated with said subset of retailers, wherein modified values are displayed comparing sales performance of the subset retailers.

31. The method of claim 30, wherein only data corresponding to the subset of the lottery retailers that satisfy the query are included in the modified table.

32. A computer readable medium encoded with computer program code, wherein when the computer program code is executed by a processor, the processor performs a computer implemented method for processing lottery sales data, comprising the steps of:
(a) causing display of a table on a computer, the table containing data representing lottery ticket sales for a plurality of lottery retailers, wherein said table contains values of an index that compares sales performance of each of the lottery retailers listed in said table;
(b) enabling a user of the computer to query the data in the table based on at least one criterion from a predetermined list of criteria; and
(c) modifying the table to contain a listing of a subset of lottery retailers from said plurality of lottery retailers that meet said at least one criterion, said table further containing data representing lottery ticket sales associated with said subset of retailers, wherein modified values are displayed comparing sales performance of the subset retailers.

33. The computer-readable medium of claim 32, wherein only data corresponding to the subset of the lottery retailers that satisfy the query are included in the modified table.

34. A computer implemented system for processing lottery sales data, comprising:
(a) means for causing display of a table on a computer, the table containing data representing lottery ticket sales for a plurality of lottery retailers, wherein said table contains values of an index that compares sales performance of each of the lottery retailers listed in said table;
(b) means for enabling a user of the computer to query the data in the table based on at least one criterion from a predetermined list of criteria; and
(c) means for modifying the table to contain a listing of a subset of lottery retailers from said plurality of lottery retailers that meet said at least one criterion, said table further containing data representing lottery ticket sales associated with said subset of retailers, wherein modified values are displayed comparing sales performance of the subset retailers.

35. The system of claim 34, wherein only data corresponding to a subset of the lottery retailers that satisfy the query are included in the modified table.
